(19) United States
(12) Patent Application Publication
(10) Pub. No.: US 2016/0230729 A1
(43) Pub. Date: Aug. 11, 2016

(54) Device for Fastening at Least One Fuel Injection Nozzle

(71) Applicant: Neander Motors AG, Kiel (DE)

(72) Inventors: Claus BRUESTLE, Nordheim (DE); Rupert BAINDL, Geretsried (DE)

(21) Appl. No.: 15/016,533

(22) Filed: Feb. 5, 2016

(30) Foreign Application Priority Data
Feb. 7, 2015 (DE) 10 2015 001 614.8

(51) Int. Cl. F02M 61/14

(52) U.S. Cl. CPC F02M 61/14

(57) ABSTRACT

This device is designed to fasten at least one fuel injection nozzle for an internal combustion engine, and the fuel injection nozzle is inserted into the bore of a cylinder head and feeds fuel into a combustion chamber between cylinder head and a piston by a nozzle tip, the fuel injection nozzle being kept in position at a housing section of the internal combustion engine by means of a holding device and one or a plurality of mounting screws in such a manner that the holding device clamps the fuel injection nozzle against a stop in the bore of the cylinder head. In order to optimize the device, the holding device of the fuel injection nozzle comprises a jacket pot surrounding the latter at least in sections, which has, on the one hand, a mounting flange and, on the other hand, a holding socket to secure the fuel injection nozzle at least in the axial direction, and the holding device is, via the mounting flange, held in position at the housing section by means of the mounting screws.

The invention relates to a device for fastening at least one fuel injection nozzle for an internal combustion engine according to the preamble of patent claim 1.

From the publication JPH03182680 A, a device is known by which a fuel injection nozzle of an internal combustion engine is disposed in a bore of a cylinder head. The device has a holding device designed in the manner of a two-armed lever which engages, on the one hand, with a first arm at a collar-like stop of the fuel injection nozzle and, on the other hand, with a second arm at a screw head of a cylinder head screw. A mounting screw extends between the two arms, which is screwed into a thread in the cylinder head and clamps the fuel injection nozzle against a stop in the bore of the cylinder head by inter-positioning a seal. Moreover, a nozzle tip of the fuel injection nozzle penetrates a through-hole in the cylinder head and, by doing so, is connected to a combustion chamber of the internal combustion engine.

An assembly for attaching an injection nozzle in a holder can be seen from the publication DE 195 54 065 A1, which has a receiving aperture for the injection nozzle. A clamping element is mounted at the injection nozzle. The clamping element is connected to the holder by means of mounting screws and, that is, in such a manner that the injection nozzle positively fits against a stop in the receiving aperture. A sealing disk is installed between injection nozzle and stop. Additionally, a nozzle tip of the injection nozzle penetrates a through-hole bore in the holder so that fuel is infeedable into a downstream combustion chamber.

The publication DE 26 49 357 describes a connection of a fuel injection nozzle with a cylinder head of an internal combustion engine. The fuel injection nozzle rests with a guide shaft in a bore of the cylinder head. Outside of the bore, a pressure piece acts upon the fuel injection nozzle in such a manner that, by means of a mounting screw, said fuel injection nozzle is clamped in the axial direction against a stop in the bore. Longitudinal center axes of the mounting screws and of the fuel injection nozzle run at a defined distance to one another.

It is the object of the present invention to design a device for fastening at least one fuel injection nozzle by a holding device, which is characterized by good functioning, easy installation and simple implementability.

According to the present invention, this object is achieved by the features of patent claim 1. Further features embodying the present invention are included in the dependent claims.

The primary advantages achieved by the present invention are to be seen in that the device having the holding device holds the fuel injection nozzle at the housing section of the internal combustion engine perfectly in place. In this instance, the fuel injection nozzle may be easily connected to the holding device as well as the holding device may be easily connected to the housing section; the disassembly is similarly simple. Within this context, the holding device implementable by the skilled person is also to be mentioned. The structural design of the holding device having a mounting flange, jacket pot and mounting flange sets standards in the field of fastening fuel injection nozzles. It is to be highlighted that at least the jacket pot is formed by a rotationally symmetrical body to which the mounting flange and the holding socket serving for axial and radial locking are connectable without difficulty, and commercial feather keys serving to secure the fuel injection nozzle into the holding socket. A superior fastening of the holding device is possible if the mounting screws are disposed in an evenly distributed manner over a circumferential center line of its mounting flange. An outstanding connection of the holding device via the mounting flange and the mounting screws is achieved in that said holding device is attached at the housing section constituting a valve cover of the internal combustion engine. An excellent interaction of the holding device with the fuel injection nozzle results if the jacket pot, which, for example, is made out of sprung steel, has defined elastic properties in the axial direction. This is supported in that the jacket pot is implemented in the manner of a converging conical shell, starting from the mounting flange in the direction of the holding socket. Furthermore, it is positive that the shell of the jacket pot adjacent to the mounting flange is provided with a first conical shell section extending only over a partial length of the shell, a second shell section extending from one end of the partial length of the shell to the holding socket. It is advantageous in this embodiment that the first shell section encloses, with reference to a longitudinal center axis of the jacket pot, a smaller angle than a corresponding angle of the second shell section.

A high-ranking further embodiment of the holding device is achieved in that the device is well suited to receive two fuel injection nozzles and that it has a first and a second jacket pot having a first and a second holding socket. For instance, the first and the second jacket pots are combined into an assembly substantially integrally manufactured which rests with a surrounding support flange on a corresponding receiving plane at the housing section constituting a valve cover. This embodiment is complemented in a particular manner in that a cross sectionally U-shaped groove for receiving a sealing body, which is operative between groove and assembly, is provided next to the receiving plane of the valve cover. Finally, this holding device is optimized in a targeted fashion in that a single mounting screw, which is operatively connected to a thread of the cylinder head and which holds the assembly in place at the valve cover in a functionally adequate way, is situated in a longitudinal center plane between the first and the second jacket pot.

The drawings show exemplary embodiments of the present invention, which are subsequently described in more detail.

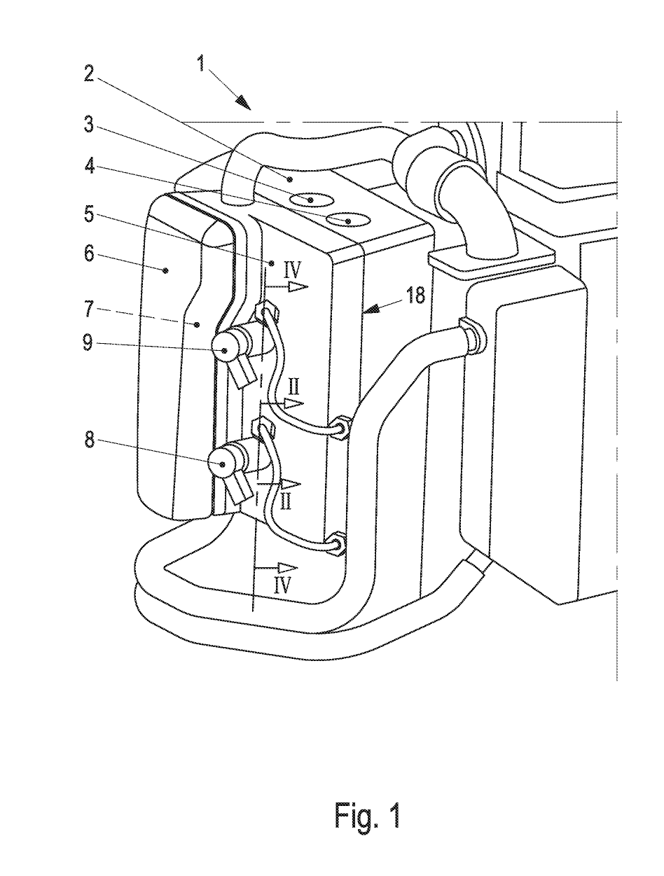

FIG. 1 shows a schematic slanted partial view onto an internal combustion engine;

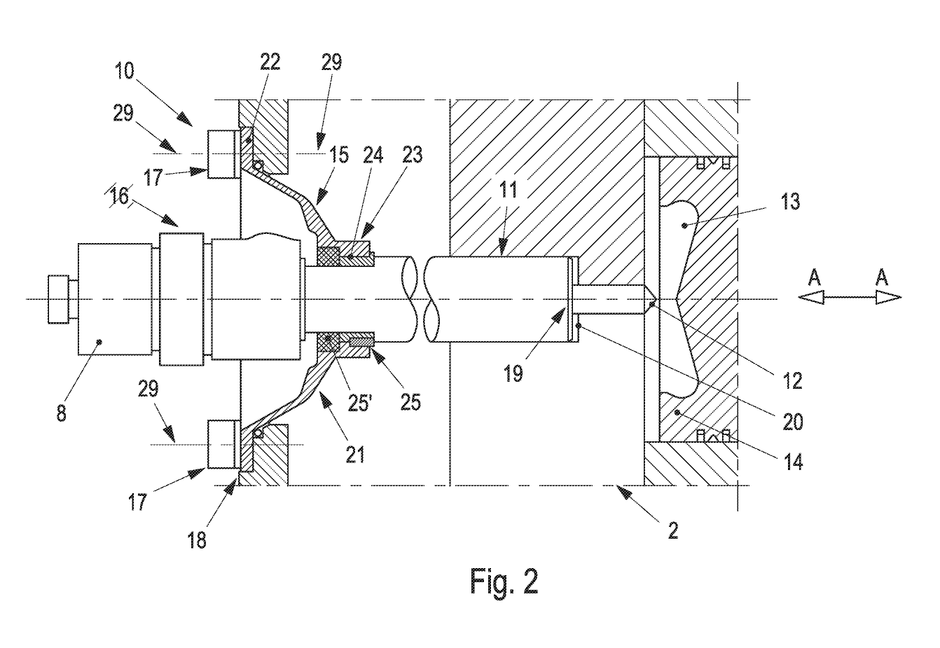

FIG. 2 shows a section along line II-II of FIG. 1 on a larger scale, having a first embodiment of a holding device for a fuel injection nozzle—version I;

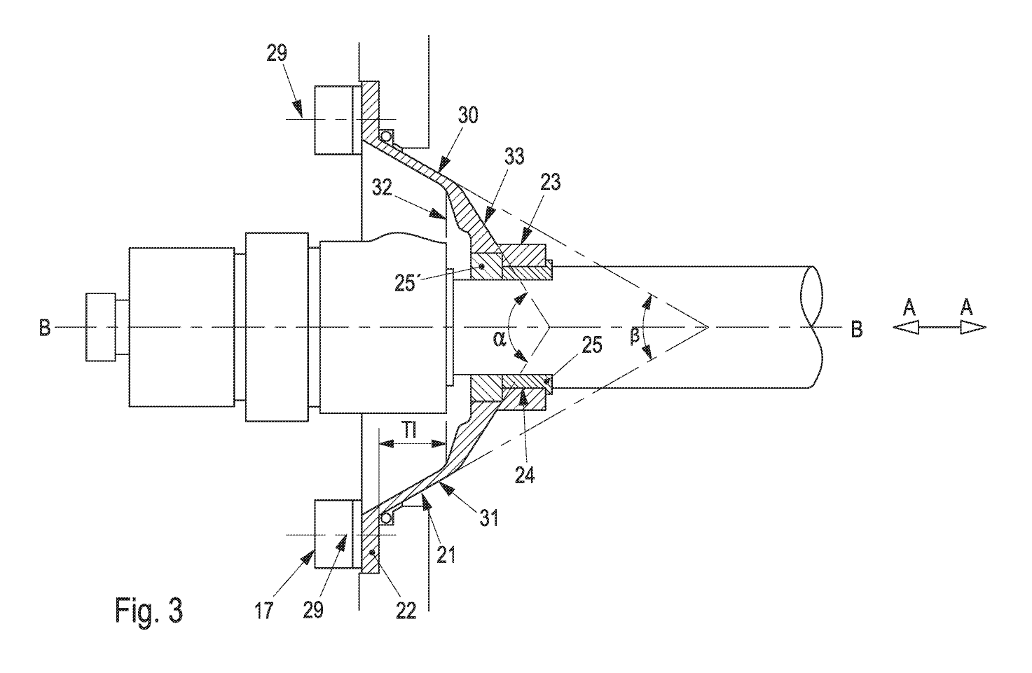

FIG. 3 shows a detail X of FIG. 2 on a larger scale;

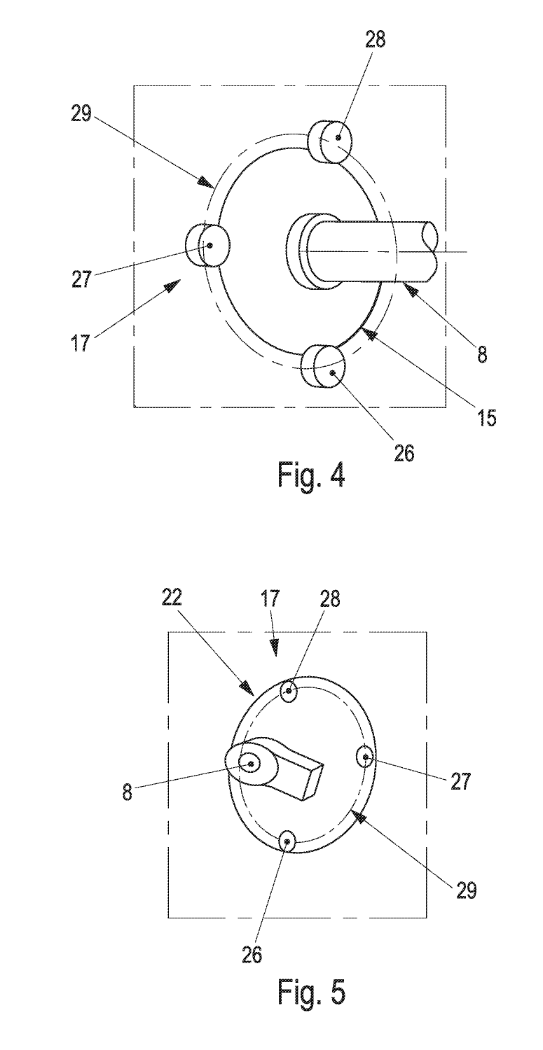

FIG. 4 shows a schematic slanted view of an interior side of a valve cover, having a screw connection of the holding device according to FIGS. 2 and 3;

FIG. 5 shows a schematic slanted view from above onto the holding device having a fuel injector;

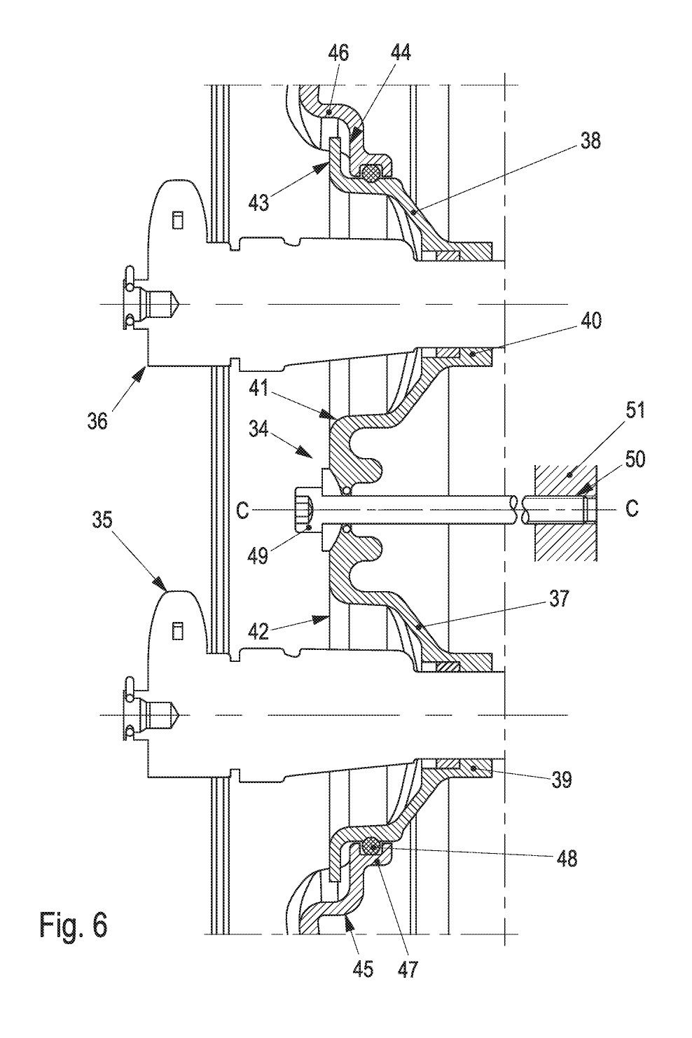

FIG. 6 shows a section along line IV-IV of FIG. 1, having a holding device for a plurality of fuel injection nozzles—version II; and

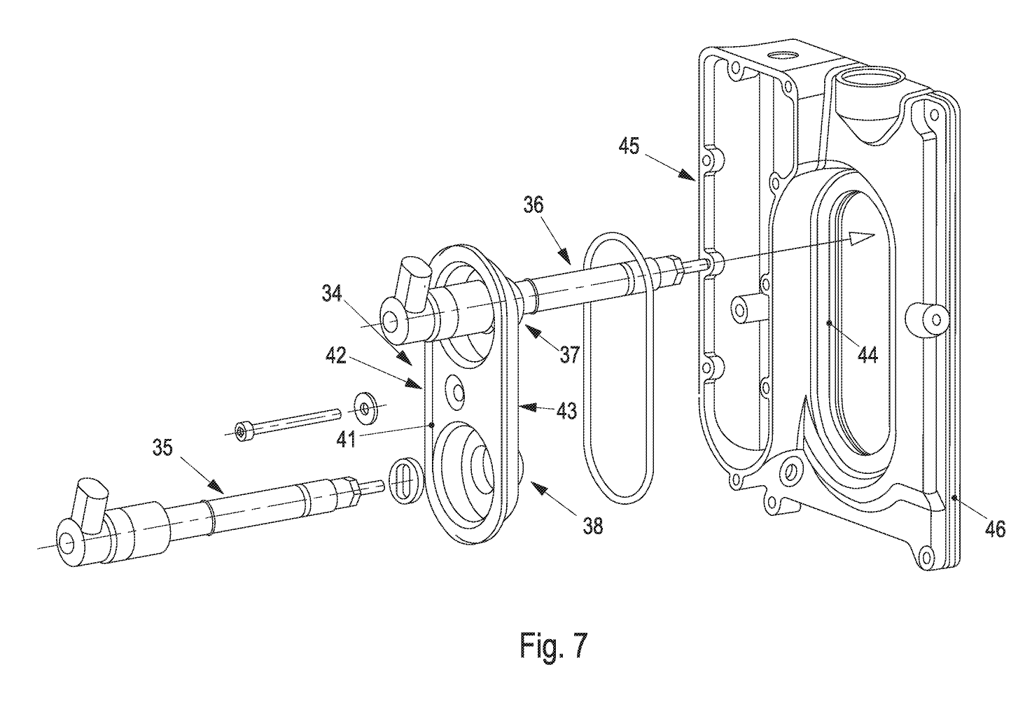

FIG. 7 shows an isometric explosion drawing of the holding device according to FIG. 6.

There exists a cylinder head 2 of an internal combustion engine 1, which accommodates camshafts 3 and 4 actuating two not-shown valves and which is screwed together with a valve cover 5. A covering hood 6 of an intake chamber 7, which is at least partially formed by valve cover 5, extends approximately parallel to valve cover 5—FIG. 1. Internal combustion engine 1 is designed as an outboard engine for actuating a ship propeller and is integrated into a boat. In addition, this internal combustion engine has two parallel crankshafts which are aligned perpendicular to a waterline of the boat. Both crankshafts are actuated by two pistons which are moved back and forth in horizontal bores by cylinders of a cylinder crank housing. In doing so, each piston acts upon said crankshaft using two connecting rods. Moreover, internal combustion engine 1 operates according to the diesel method and, that is, with direct injection; common-rail system. From the publication DE 10 2012 015 907 B3, the latter, specific features of internal combustion engine 1 having two parallel crankshafts follow from the description and illustrations in a plausible manner.

The direct injection system comprises fuel injection nozzles 8 and 9 for the cylinders, for the fastening of which a device 10 is provided at valve cover 5 of internal combustion engine 1—FIG. 2. Each fuel injection nozzle, for example, fuel injection nozzle 8, is at least in sections inserted into a bore 11 of cylinder head 2, fuel injection nozzle 8 feeding fuel, using a nozzle tip 12, into a combustion chamber 13 between cylinder head 2 and a piston 14. With holding device 15, fuel injection nozzle 8 forms, for example, pre-installed assembly 16, and holding device 15 is, by means of a screw connection 17, fixedly connected to a housing section 18 of internal combustion engine 1. In this instance, holding device 15 clamps—version I—the fuel injection nozzle against a stop 20 in bore 11 of cylinder head 2 by inter-positioning a sealing plate 19.

Holding device 15 comprises a jacket pot 21 surrounding fuel injection nozzle 8 in areas, which on a side facing away from nozzle tip 12 has a mounting flange 22. At a distance to mounting flange 22, a holding socket 23 delimiting a partial area 22 of fuel injection nozzle 8 by a bore 24 is provided at jacket pot 21. Feather keys 25 illustrated only schematically are operative between holding socket 23 and fuel injection nozzle 8, as a result of which fuel injection nozzle 8 is secured in the axial and radial direction. Within holding socket 23, a sealing body 25′ is provided on a side facing mounting flange 22, which is operative between a bore section of bore 24 and a shaft area of fuel injection nozzle 8 and which prevents fuel from spilling.

Jacket pot 21 is a rotationally symmetrical body which is integrally manufactured from mounting flange 22 and holding socket 23—FIG. 3; however, it is also conceivable to produce said parts separately from one another and to assemble them afterwards. Screw connection 17 comprises mounting screws 26, 27 and 28, which are evenly disposed over circumferential center line 29 of annular mounting flange 22, and holds holding device 15 at housing section 18 constituting valve cover 5—FIG. 2.

Jacket pot 21 projecting into valve cover 5 has defined elastic properties in axial direction A-A. Spring steel is a suitable material for jacket pot 21; however, composites can also be used for the manufacture of said jacket pot. Jacket pot 21 is designed, starting from mounting flange 22 in the direction of holding socket 23, in the fashion of a tapered conical shell 30, said conical shell, starting at mounting flange 22 in the direction of holding socket 23, being provided with a first shell section 31 extending only over a partial length TI of shell 30. A second shell section 33 extends from an end 32 of partial length TI of first shell section 31 in the direction of holding socket 23. First shell section 31 encloses, with reference to a longitudinal center plane B-B, a smaller angle a than a corresponding angle β of second shell section 33.

A holding device 34 is configured to receive two fuel injection nozzles 35 and 36—version II—and is composed of a first jacket pot 37 and a second jacket pot 38 which are connected to a first holding socket 39 and a second holding socket 40. First and second jacket pots 37 and 38 are combined via a frame 41 into a substantially oval assembly 42 which is, for example, made out of metal, plastic or the like and which is integrally manufactured, for example, by deforming. Assembly 42 or frame 41 is provided with a surrounding support flange 43 which rests upon a corresponding receiving plane 44 of a housing section 45 in the shape of a valve cover 46.

Adjacent to receiving plane 44 of valve cover 46, a U-shaped groove 47 is provided in a cross section which is inclined sideways by 90°. Groove 47 serves to accommodate a sealing body 48 which is operative between groove 47 and frame 41 of assembly 38. Finally, a mounting screw 49, which is operatively connected to a thread 50 in a cylinder head 51 and which keeps assembly 32 in position under tension at valve cover 42, is provided in a longitudinal center plane C-C between first jacket pot 37 and second jacket pot 38.

What is claimed is:

1. A device for fastening at least one fuel injection nozzle for an internal combustion engine, and the fuel injection nozzle is inserted in a bore of a cylinder head and infeeds fuel into a combustion chamber between cylinder head and a piston by a nozzle tip, wherein the fuel injection nozzle is kept in position at a housing section of the internal combustion engine by means of a holding device and one or a plurality of mounting screws in such a manner that the holding device clamps the fuel injection nozzle against a stop in the bore of the cylinder head, characterized in that the holding device (15) of the fuel injection nozzle (for example, fuel injection nozzle 8) comprises a jacket pot (21) surrounding the latter at least in sections, which has, on the one hand, a mounting flange (22) and, on the other hand, a holding socket (23) to secure the fuel injection nozzle (8) at least in the axial direction and in that the holding device is held via the mounting flange in position at the housing section by means of the mounting screws.

2. The device according to claim 1, wherein at least the jacket pot (21) of the holding device (15) is formed by a rotationally symmetrical body.

3. The device according to claim 1, wherein three evenly distributed mounting screws (26, 27 and 28) are disposed at a circumferential center line (29) of the, for example, annular mounting flange (22).

4. The device according to claim 1, wherein the holding device (15) is attached via the mounting flange (22) and the mounting screws (26, 27 and 28) at the housing section (18) constituting a valve cover (5) of the internal combustion engine (1).

5. The device according to claim 1, wherein one or a plurality of feather keys (25) is/are operative between holding device (15) and fuel injection nozzle (8).

6. The device according to claim 1, wherein the jacket pot (21), made, for example, out of sprung steel, has defined elastic properties in the axial direction (A-A).

7. The device according to claim 1, wherein the jacket pot (21) is implemented in the fashion of a conical shell (30) starting from the mounting flange (22) in the direction of the holding socket (23).

8. The device according to claim 7, wherein the shell (30) of the jacket pot (21) adjacent to the mounting flange (22) is provided in the direction of the holding socket (23) with a first conical shell section (31) extending only over a partial length (TI) of the shell (30), wherein a second shell section (33) extends from one end of the partial length (TI) of the first shell section (31) up to the holding socket (23).

9. The device according to claim 8, wherein the first shell section (31) encloses, with reference to a longitudinal center plane (B-B) of the jacket pot (21), a smaller angle (a) than a corresponding angle (p) of the second shell section (33).

10. The device according to claim 1, wherein a holding device (34) is configured to receive two fuel injection nozzles (34 and 35) and has a first and a second jacket pot (37 and 38) as well as a first and a second holding socket (40 and 41).

11. The device according to claim 10, wherein the first and the second jacket pot (38 and 39) are combined into an assembly (42) substantially integrally manufactured which rests with a surrounding, for example, oval support flange (43) on a corresponding receiving plane (44) of a housing section (45) constituting a valve cover (46) of the internal combustion engine (1).

12. The device according to claim 10, wherein a cross sectionally U-shaped groove (47) for receiving a sealing body (48), which is operative between groove (47) and assembly (42), is provided adjacent to the receiving plane (44) of the valve cover (46).

13. The device according to claim 1, wherein a mounting screw (49), which is operatively connected to a thread (50) in a cylinder head (51) and which keeps the assembly (42) in position under tension at the valve cover (46), is situated on a longitudinal center plane (C-C) between the first and second jacket pot (37 and 38).
